(19) United States
(12) Patent Application Publication
(10) Pub. No.: US 2008/0174084 A1
(43) Pub. Date: Jul. 24, 2008

(54) CRUTCH STROLLER

(76) Inventor: LARRY ELLIS GEE, Chicago, IL (US)

Correspondence Address: LARRY E. GEE, SR., 10147 S. WALLACE STREET, CHICAGO, IL, 60628, US

(21) Appl. No.: 12/015,094

(22) Filed: Jan. 16, 2008

Related U.S. Application Data
(60) Provisional application No. 60/885,813, filed on Jan. 19, 2007.

(51) Int. Cl. A61H 3/04

(52) U.S. Cl. 280/200

(57) ABSTRACT

A mobility aid (FIG. 1) design for providing stabilized mobility support by the practical use of a two sided vertically supported rigid frame comprising front and rear bilaterally double support members (12), (12a), (13), (13a), (15), and (15a), and not limited to but preferably of aluminum construction to include a plurality of upper and lower substantially identical bilaterally horizontal and vertical tubular main frame members (17), (18), (19), (20), (22), (27), (28), and (29), supported on a plurality of sufficiently sized wheels (26), and (30), attached to the underside of the main frame (26), and (30), with predetermined spacing. Base members (22), (28), and (29), are sufficiently elevated-providing for unhindered foot movement during mobilization. A guide wheel assembly (23), (25), (25b), (26), and (26a), is vertically attached at a contiguously anterior junction surface of the two sided main frame assembly (20), and (23), thereby providing selective directional steering. Hand brake controls (16), secure by clamps to riser connectors (15), activate brakes (31).

### CROSS-REFERENCE TO RELATED APPLICATION

This application claims the benefit of provisional patent application Ser. No. 60/885,813 filed Jan. 19, 2007 by the present inventor.

### FEDERALLY SPONSORED RESEARCH

Not Applicable

### SEQUENCE LISTING OR PROGRAM

Not Applicable

### BACKGROUND OF THE INVENTION

1. Field of the Invention

The present invention relates to mobility aids, specifically to those used as means to combine the features of both stability and mobilized body support for an individual with manifested physical limitations and abilities that are the results of generalized weakness due to sickness, crippling bone disease, deformities, and post surgical procedures.

2. Prior Art

Mobility aids as forms of prior art were designed as a means of assisting individuals that experienced decreased leg strength or deformities; however, during the recovery process of these individuals, durable medical equipment companies most often supplied them with either the conventional handheld walker, rolling walker, walking cane, or crutches individually, but none of those devices were capable of supplying the assistance required for the rehabilitation of weak legs when so many other areas of the body needing support was totally neglected. Originally, these devices were thought to give sufficient stability and support; however, since an adequate sense of balance, strength in the arms, legs, wrists and back areas are also required to operate these devices, the individual using these devices would soon become exhausted and limit their activities of exercise resulting in prolonged rehabilitation.

A walker, as a mobility aid of prior art has stability due to the construction of the base, but since the stability feature of that walker is limited to stabilizing the walker and not the individual user, it is not sufficiently accommodating alone to provide adequate assistance in the mobilization of an individual, whereby the resulting effects generally produced significant postural and back problems or injury due to the lack of proper body alignment and support.

Crutches, have a definite advantage over a walker, because they provide more contact points between the device and the individual user, wherein means to relieve stress from the back areas and weight off the legs is provided. But crutches alone hinder the endurance of the weak, because most of the individuals energy is used lifting the crutches with each step taken.

An apparatus combining both the stability of a walker and the support features of crutches, increases physical endurance by alleviating stresses, and substantially decreases limitations on independence, and improves security of safe mobility.

Dating back as far as the 1800's inventors have made several unsuccessful attempts to combine the advantages of both the walker and crutches; however, during the production of those earlier models such factors as the bulk weight, size of the device, the localized limitations on maneuverability and transportation of the device were not considered for life-styles of today. One such invention was U.S. Pat. No. 130,283 Aug. 6, 1872 to S. A. Darrach of Orange, N.J., which was too large to easily transport by any vehicle, not conveniently maneuverable in a privately owned home, and the usage would be limited to hospitals and nursing homes.

Another invention, U.S. Pat. No. 4,226,413 Oct. 7, 1980 to Wilma J. Daugherty of Garden Grove, Calif. concentrated more concerns on a foot brake design feature, which required the user to lift one foot in order to apply the brake, whereby unsteady gait could cause falls and injury due to imbalance. Also, the single bilateral support bar member was so close to the rear of the device, that backwards falls would be the inevitable. Thus, safety was not a feature of that device.

Another mechanism U.S. Patent No. 20010048206 to Douglas Parsell of Ridgeland, Miss., Dec. 6, 2001 list claims of stability, but there is more emphasis on spring loaded pistons used to apply the brakes, that only functioned when adequate pressure on handles were-applied. If the user did not have adequate strength this device would be dangerous on declining surfaces, add work load for weakened wrists and arms.

Thereafter, U.S. patent No. 2004/0020525 A1 Feb. 5, 2004 to Harry Lev of Youngstown, Ohio created a device with small castors that would present a difficult situation during attempts to mobilize the device on carpet, ruff surfaces, and tilting over the device during maneuvers. Another danger of this device was instability, due to the hand grip placements being so far to the rear of the upper “U” shaped member, making this device unsafe to operate.

Another invention under patent No. 20060254631 to Larry Mullholand, of Santa Paula, Calif. Nov. 16, 2006 wherein it is mentioned that this device relates to a weight relieving walker; however, it states in the abstract of this device that a seat is positioned to support the pelvis of the individual user to help propel the device on a “hands free” basis, but if this is a hands free operation, how does it relieve weight?.

Whether a mobility aid is built for walking, standing or to minimize the ambulatory efforts of the individual user, safety should always be a considering factor during production and selection of a device.

Objects and advantages of the present invention are:
a) To provide an assistive mobility aid combining the stability of a walker and the support advantages of a-durable crutch assembly;
b) To provide an assistive mobility aid whose production allow for convenient folding and adjustability to accommodate easy-transport and storage;

Objects and advantages of the present invention are:
c) To provide an assistive mobility aid wherein service is dependable to post operative patients, orthopedic patients, those suffering from deformities, injuries, bone and joint disease, and especially servicemen with injuries to lower limbs.
d) To provide an assistive mobility aid wherein a superior frame is provided for greater and reinforced support members.
e) To provide an assistive mobility aid which includes underside base members which are substantially elevated to allow for unhindered foot movement and avoidance of stumbling over a low base member during mobility;

Further objects and advantages are to provide a sturdy center of gravity for body support to allow for greater safety during mobility; bilateral hand brakes providing positive direct pressure to rear wheels by a slight squeezing on hand control for application of brakes. Still further objects and advantages will become apparent from a consideration of the ensuing description and drawings.

### SUMMARY

In accordance with the present invention a mobility assistance aid combining the features of both stability and support, comprising: a sturdy, rigid tubular material having sufficient durability and a predetermined center of gravity with a vertically standing two sided “V” shaped open entry frame in which an individual user stands independently with support assist, wherein selective directional steering and bilateral hand braking is controlled, whereby mobilized body support for an individual with manifested physical limitations and abilities is provided.

### DRAWINGS—FIGURES

In the drawings, closely related figures have the same number but different alphabetical suffixes.

FIG. 1 shows a simplified left sided view of the crutch stroller,

FIG. 2 shows an over-head view of the right and left sides of the “V” shaped open end entry of the main frame.

FIG. 3 shows a front guide wheel, rear wheel assembly with brake assembly, a hand brake and arm-pit pad assembly,

FIG. 4 shows an individual standing within the “V” shaped open entry frame,

FIG. 5 shows a standing simplified version of the crutch stroller,

FIG. 6 shows a front view of the guide wheel assembly

| | |
|---|---|
| 10 | arm pad support |
| 10a | arm pads |
| 11 | horizontal connectors |
| 12 | vertical support bar ® |
| 12a | vertical support bar (L) |
| 13 | adjustment hole |
| 13a | rear support bar |
| 14 | adjustment pins |
| 14a | adjustment holes |
| 15 | riser |
| 15a | riser connectors |
| 16 | hand brake |
| 17 | platform tower (front) |
| 18 | platform tower (rear) |
| 19 | descending member |
| 20 | ascending member |
| 21 | caster plate & bolt |
| 22 | ascending base member |
| 23 | tubular member (vertical) |
| 24 | caster bolt |
| 25 | swivel casters |
| 26 | 7½ inch guide wheel |
| 26a | front wheel axel |
| 27 | platform riser |
| 28 | base member |
| 29 | descending base |
| 30 | rear wheels |
| 31 | brakes |
| 32 | rear axel |
| 33 | brake connector |
| 34 | brake connector |
| 35 | folding bracket |
| 36 | man in open space |

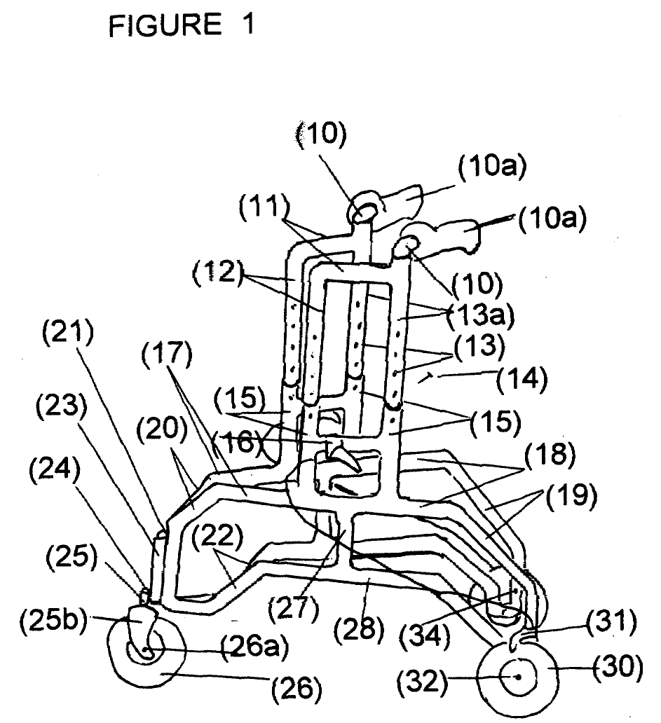

### DETAILED DESCRIPTION—FIGS. 1-6 PREFERRED EMBODIMENT

FIG. 1 Showing a left sided view of the crutch stroller demonstrates from top to bottom 10a, bilateral arm pads adhesively attached to “L” shaped arm pad support bars 10, having the lower end inserted into the upper end of the rear vertical support bars 13a. Bilateral front and rear adjustable vertical support bars 12, 12a, 13, and 13a, are bilaterally connected at the upper surface by horizontal connectors 11, to reinforce the vertical support bars 12, 12a, 13, and 13a. the lower distal ends of the vertical support bars 12, 12a, 13a, being male ends are inserted into the upper female openings of the bilateral risers 15, allowing for the vertical descent of the vertical support bars 12, 12a, 13, and 13a, whereby accommodating the adjustability feature of the vertical supports by the placement of pins 14, into adjustment holes 14a. Each vertical riser 15, is connected front to rear bilaterally by riser connectors 15a, to accommodate a stationary hand support and a stable location for the hand brake control.

FIG. 1 continues with the attachment of the vertical risers 15, by welded joints at predetermined distances apart and centered on the upper main frame platform towers 17, and 18, whereby the center of gravity is maintained, two vertical tubular members 23, are contiguously connected by welded joints to upper and lower joints on the swivel caster 25, the two vertical tubular members are stabilized and held in place by a caster plate and bolt 21, the two vertical tubular members 23, are attached to bilaterally ascending tubular members 20, by welded joints to form the anterior portion of the main frame, horizontally bilateral base members 22, ascends at an approximate 45 degree angle after which continues on to form a predetermined horizontal base member 28, to descend forming a descending base member 29, whereby the base is substantially elevated to allow for plenty of foot and leg movement during ambulation, the descending base member 29 continue on to form a “U” shape member for rear wheel attachments by the use of rear axels 32, and then ascends to join the descending member 19.

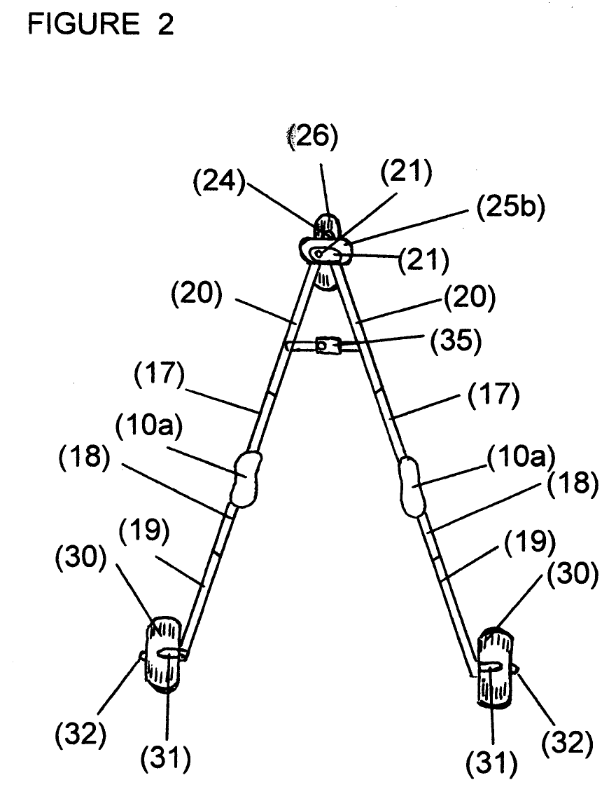

FIG. 2 is an overhead perspective view of the crutch stroller showing a “V” shaped, open end entry space for the individual user to stand during the operation phase, which includes wheel locations 26, and 30, positive pressure brakes 31, arm pad locations 10a, folding bracket 35, ascending members 20, descending tubular members 19, front platform members 17, rear platform members 18, and rear axels 32.

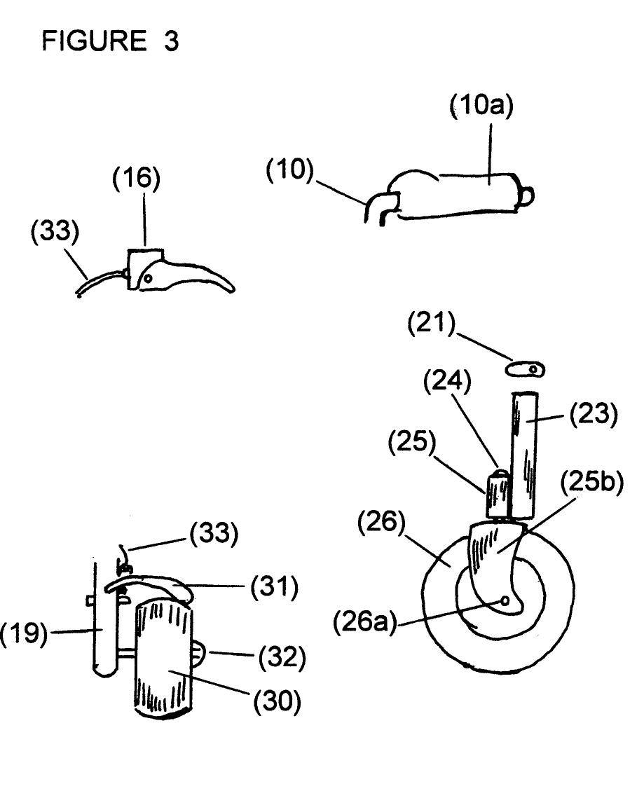

FIG. 3 is a rear view of the descending tubular member 19, illustrating the brake assembly 32, 34, 33, and a lateral side view of the hand brake control 16, and including a side view of the guide wheel 26, front axel, caster bolt 24, a swivel caster assembly 25, and one of two vertical tubular members 23, and caster plate 21.

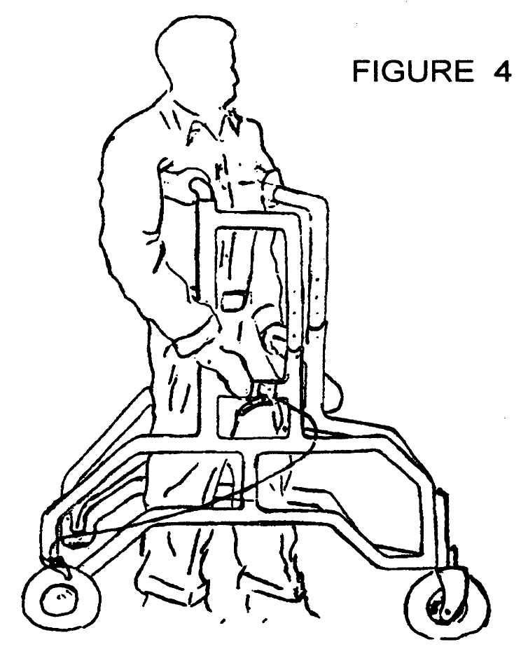

FIG. 4 is a simplified right sided perspective view of an individual user of the crutch stroller standing within the open entry space of the device during operation.

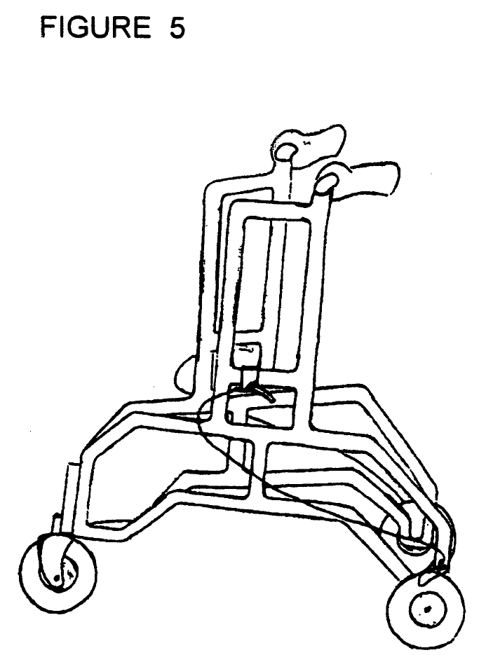

FIG. 5 shows a plain left sided view of the crutch stroller.

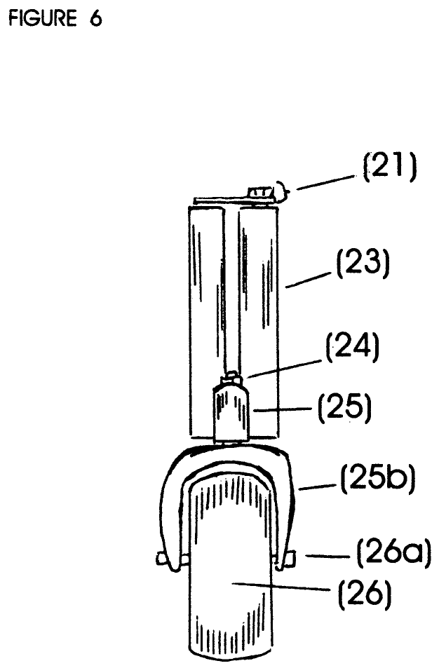

FIG. 6 is a front perspective-view of the guide wheel 26, and related parts

### Operation—FIGS. 1, 2, 3

The practical use of the crutch stroller is typically implemented by the determinations and order of a physician that are based on the capable strengths and weaknesses of a patient or individual to be a candidate for the prescribed use of a mobile device either in home, hospital, nursing facility, physical therapy unit, post operative orthopedic patients, or servicemen with impaired ambulatory skills due to injury.

Thereafter, usage is initiated with an individual standing within the “V” shaped open entry space as shown in FIGS. 2, and 4, so that each armpit rest comfortably upon bilateral arm pads 10a, as each arm is extended in a downward position with both hands resting on each riser connector 15a, which serves as the second support location. This position allows for three contact point-locations for support: the armpits, hands, and feet, that enable correct posture, reinforced support, steady gait during independent ambulation, and stability due to the envelopment of the body on both by a sturdy bilateral main frame 20, 17, 18, and 19 FIG. 1, and sturdy bilateral vertical risers 15, FIG. 1, to include sturdy support towers 12, 12a, and 13a, FIG. 1.

To operate this-present invention the individual user will ambulate independently step-by-step while weight is evenly distributed on both feet, during which time the weight on the legs and feet is minimized by the additional support of armpit pads 10a, and the placement of the hands on the riser connectors 15a. Plenty of foot room is allowed due to the elevation of the bilateral base members 22, 28, and 29. Steering is accomplished by upper body movement to the left or right resulting in the swivel caster 25, FIG. 1, 2, and 3 allowing the guide wheel 26, FIGS. 1, 2, and 3, to shift either left or right. Brakes are applied by squeezing the bilateral hand brake controls 16, FIG. 1, which results in a positive pressure on the rear wheels 30, FIG. 1.

Movement, turns, and stops are completely controlled by the patient or individual independently, while vertical adjustment in height of the support bars 12, 12a, 13, and 13a can be obtained the vertically lowering or raising the vertical supports bars 12, 12a, 13, and 13a, FIG. 1, as a unit and the placement of pins 14, into the pin holes 14a FIG. 1, for stability.

### Advantages

Advantages of the crutch stroller include but is not limited-to-plenty of leg and foot room during ambulation due to the elevation of the bilateral base members 22, 28, and 29, two bilateral support bars 12, 12a, 13, and 13a, centered for reinforced center of gravity, a rigid adjustable open entry sturdy frame, easily transported due to the retraction of the support bars 12, 12a, 13, and 13a, into the open end risers 15, wheels large enough to accommodate ease of movement on ruff or smooth surfaces, requires little storage space, not limited in structural integrity when folded, and has stability and support with a reinforced base.

### Additional Embodiments

There are various possibilities with regard to the construction. Since the present invention can be ordered according to the individual user's size, the construction material can be optional: meaning that the tubular construction can be formed either from aluminum or reinforced plastics.

Another alternative embodiment would be the use of an attachable basket for carrying small packages or necessities during ambulation that would rest on, and be attached to the front platform towers 17, FIG. 1, by means of Velcro straps.

Another alternative embodiment is a plastic padded seat that would rest on the rear platform towers 18, FIG. 1.

In this exemplary model of a combination walker and crutches, it is clearly a far more superior mobility aid than stand alone crutches, regular roll walkers, and any of the aforementioned prior art attempts at creating a device such as this present invention: for even though the stand alone crutch give support, they do not accommodate the user with a stable base, and regular roll walkers have a stable base; however the lack of support for the back, wrists does not relieve very much pressure from weak lower extremities, which will surely result in frequent periods of exhaustion and limited exercise.

The aforementioned prior art references all neglected to accomplish successfully the safety features of enhanced vertical support bars such as in the present invention, nor have they maintained a center of gravity for support bars that will avoid falls backwards during use. And without the features of support, stability, or ease of transport by private vehicle, use outside of a hospital, nursing home or institution would be limited. The present invention clearly has bilaterally enhanced double vertical support bars that are positioned for a safe center of gravity, stability and support with a stabilized base, a design for ease of transport by private vehicle without the task of disassembly of multiple parts, light weight, bilateral handbrakes and inexpensive to manufacture.

### Conclusion, Ramifications, and Scope

In this present invention you find a novel design created with both physical and structural differences from prior art designs for a mobile aid device that combines both the stability of a walker and the support feature of crutches. Among the structural differences from prior art designs are the height elevation of the base members 22, 28, and 29, FIG. 1, that allows for unhindered leg and foot movement without stumbling over a low base member, and further presenting and enhanced elongated tubular main frame that is reinforced with substantially identical upper and lower members comprising 17, 18, 19, 20, 22, 28, and 29, FIG. 1.

Other structural differences are, found in the vertical support members 12, 12a, 13, and 13a, FIG. 1, that are constructed with bilaterally adjustable vertical support members; the handbrake design is bilaterally positioned to maintain a center of gravity operation; bilaterally double vertical risers 15, FIG. 1, are joined by connectors 15a, FIG. 1, to provide means for enhanced adjustable support members 12, 12a, 13, and 13a FIG. 1, by decreasing the length of all support members, whereby all support members are strengthened and maintain a safe center of gravity.

Physical differences include the ease of transport due to the folding bracket 35, FIG. 2, together with the adjustable support members 12, 12a, 13, and 13a will physically reduce the height and width of the present invention to allow ease of transport.

It is concluded, that this present invention having a fully foldable capability, a rigid but adjustable open entry frame, light weight sturdy members with the combining features of stability and support, to include safety and a novel design with controlled directional steering, guided easily by the individual user on carpet or ruff surfaces, and the benefit of being inexpensive to build and not limited in structural integrity when folded, and requiring little storage space at unused locations and upon transportation in private vehicles.

Although the description above contains much specificity, these should not be construed as limiting the scope of the invention, but as merely providing illustrations of some of the presently preferred embodiments of this invention.

I claim:

1. A crutch comprising: (a) a rigid material having sufficient durability to accommodate means for providing mobilized body support for an individual with manifested physical limitations and abilities; and (b) a sturdy predetermined center of gravity for body support members; and (c) a stable wheel base, whereby said mobilized body support means will be provided.

2. The crutch stroller of claim 1, wherein said rigid material is made of aluminum,

3. The crutch stroller of claim 2, wherein said rigid material made of said aluminum has corrosion resistance and durability,

4. The crutch stroller of claim 3, wherein said-aluminum having said corrosion resistance and said durability has a plurality of cylindrical tubular formations and varying lengths,

5. The crutch stroller comprising: (b) a sturdy predetermined center of gravity for body support members;

6. The crutch stroller of claim 5, wherein said sturdy predetermined center of gravity being vertical support members, are cylindrical tubular formations,

7. The crutch stroller of claim 6, wherein said cylindrical tubular formations provide means for joining to form a main frame and vertical support assembly with a sturdy predetermined center of gravity,

8. The crutch 7, wherein said means for joining comprises welded joints, each of which joins a respective one of said main frame members as a two sided, horizontally paralleling, upper and lower members a spaced locations, and contiguously joined at the anterior junction, whereby a “V” shaped open end entry of said main frame is provided,

9. The crutch stroller of claim 8, wherein said welded joints further including each of which joins said respective one of said support members as a vertically paralleling, front to back construction, perpendicularly centered between the front and rear upper main frame surface, whereby said support members maintain a sturdy center of gravity,

10. The crutch stroller of claim 9, wherein said vertically paralleling support members having a front to back construction, and joined between said front and rear upper main frame surface, further provides means for attaching arm pads, each of which joins a respective one of said arm pads to “L” shaped bars located on the upper surface of said support members by the application of an adhesive glue,

11. The crutch stroller of claim 10, wherein said means for joining comprises welded joints, each of which joins a respective one of said “L” shaped cylindrical tubular bars of minimal length to said upper surface of said body support members,

12. The crutch stroller comprising: (c) a stable wheel base,

13. The crutch stroller of claim 12, wherein said stable wheel base includes a plurality of sufficiently sized wheels joined to the underside of said main frame assembly with predetermined spacing,

14. The crutch stroller of claim 13, wherein said means for joining comprises axels, each of which joins a respective one of the two bilateral rear wheels by insertions of one end of said axels into lower descending member holes, and the other end of said axels into centered rear wheel holes then secured with lock nuts,

15. The crutch stroller of claim 14, wherein said means for joining further joins a front guide wheel by the insertion of an axel through said centered wheel hole and extending through holes on both sides of the lower swivel caster assembly,

16. The crutch stroller of claim 15, wherein said swivel caster assembly comprises two vertical tubular members of minimal size attached to an anterior swivel caster and fork by welded joints, with holes on either side of said caster fork that allow for the insertion of the guide wheel axel,

17. The crutch stroller of claim 14, wherein said swivel caster assembly is joined by welded joints, each of which joins said swivel caster and guide wheel assembly as a vertical construction, welding each of said vertical tubular members to the anterior surface of said main frame members, whereby a fully folding action of said two sides of said “V” shaped main frame is provided to accommodate easy transport and storage.
